(19) United States
(12) Patent Application Publication
(10) Pub. No.: US 2025/0321405 A1
(43) Pub. Date: Oct. 16, 2025

(54) ADJUSTABLE ANAMORPHIC PRISM FOR TUNING BEAM ASPECT RATIO

(71) Applicant: Lumentum Operations LLC, San Jose, CA (US)

(72) Inventor: Martin H. MUENDEL, Oakland, CA (US)

(21) Appl. No.: 18/789,159

(22) Filed: Jul. 30, 2024

Related U.S. Application Data
(60) Provisional application No. 63/634,581, filed on Apr. 16, 2024.

(51) Int. Cl. G02B 13/12

(52) U.S. Cl. CPC G02B 13/12

(57) ABSTRACT

In some implementations, an anamorphic prism may comprise an entrance face arranged to receive a beam with a first aspect ratio, a set of internal faces arranged to reflect the beam, and an exit face arranged to output the beam with a second aspect ratio. In some implementations, the anamorphic prism has a neutral point at which the second aspect ratio equals the first aspect ratio. The anamorphic prism may variably magnify the beam according to an angle at which the anamorphic prism is rotated relative to the neutral point.

### CROSS-REFERENCE TO RELATED APPLICATION

This Patent application claims priority to U.S. Provisional Patent Application No. 63/634,581, filed on Apr. 16, 2024, and entitled “ADJUSTABLE ANAMORPHIC PRISM.” The disclosure of the prior Application is considered part of and is incorporated by reference into this Patent Application.

### TECHNICAL FIELD

The present disclosure relates generally to beam shaping and to an optical prism that can adjust the aspect ratio of a beam to yield a beam with a desired profile.

### BACKGROUND

Optical prisms are transparent devices, typically made from optical glass or another suitable material through which light can be sent. In an optical prism, end faces are not parallel to each other, which results in a refraction (e.g., a change in beam direction) that may be wavelength-dependent due to a chromatic dispersion property of the prism material. Alternatively, in some cases, a prism may use total internal reflection, in which the output beam direction may not be wavelength-dependent. Prisms have various optical applications, including spatially dispersing different wavelength components, introducing wavelength-dependent phase changes, image rotation, polarization manipulation, and/or beam shifting, among other examples.

### SUMMARY

In some implementations, an anamorphic prism includes an entrance face arranged to receive a beam with a first aspect ratio; a set of internal faces arranged to reflect the beam; and an exit face arranged to output the beam with a second aspect ratio, wherein: the anamorphic prism has a neutral point at which the second aspect ratio equals the first aspect ratio, and the beam is magnified in one axis according to a scaling factor that is based on an angle at which the anamorphic prism is rotated relative to the neutral point.

In some implementations, an anamorphic prism includes an entrance face; an exit face; and a set of internal faces, wherein the entrance face, the exit face, and the set of internal faces are arranged to: provide a crossing optical path having an even number of internal reflections from the set of internal faces; and variably magnify a beam transmitted on the crossing optical path from the entrance face to the exit face based on an angle at which the anamorphic prism is rotated.

In some implementations, a method for tuning a beam aspect ratio includes receiving, at an entrance face of an anamorphic prism, a beam with a first aspect ratio; reflecting the beam from a set of internal faces of the anamorphic prism; and outputting, from an exit face of the anamorphic prism, the beam with a second aspect ratio, wherein: the anamorphic prism has a neutral point at which the second aspect ratio equals the first aspect ratio, and the beam is magnified in one axis according to a scaling factor that is based on an angle at which the anamorphic prism is rotated relative to the neutral point.

### BRIEF DESCRIPTION OF THE DRAWINGS

FIG. 1 is a diagram illustrating examples of optical systems and/or optical devices that may be used to adjust asymmetry in a laser beam.

FIGS. 2A-2C are diagrams illustrating example implementations of an adjustable anamorphic prism for tuning a beam aspect ratio.

FIG. 3 is a flowchart of an example process associated with tuning a beam aspect ratio using an adjustable anamorphic prism.

### DETAILED DESCRIPTION

The following detailed description of example implementations refers to the accompanying drawings. The same reference numbers in different drawings may identify the same or similar elements.

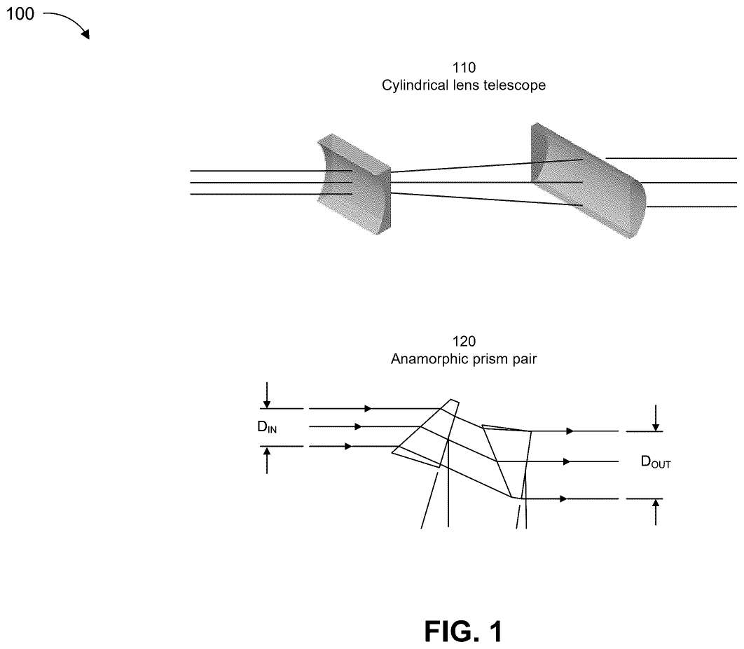

FIG. 1 is a diagram illustrating examples 100 of optical systems and/or optical devices that may be used to adjust asymmetry in a laser beam. In particular, near-perfect beam quality is an important characteristic in many laser applications, including high-power pulsed lasers. However, as power is scaled higher and higher in such laser applications, preserving a perfect beam becomes increasingly difficult, due to increasing thermal distortions and other effects. For example, beam quality generally relates to how tightly a laser beam can be focused under certain conditions (e.g., with a limited beam divergence), which may be quantified according to a beam parameter product (BPP) that is a product of a beam radius at a beam waist and a far-field beam divergence angle, or an M² factor defined as the BPP divided by a corresponding product for a diffraction-limited Gaussian beam with the same wavelength. High beam quality (corresponding to a low BPP or M² factor) is generally associated with smooth wavefronts (e.g., a strong phase correlation across a beam profile). In contrast, aberrant wavefronts may spoil beam quality and make focusing more difficult (e.g., increasing a beam divergence for a given spot size).

As described herein, in addition to having wavefront aberrations, a laser beam may develop near-field intensity distortions, such as asymmetry (e.g., beam ellipticity or non-circularity). For example, laser diodes often emit diverging beams with an elliptical and approximately Gaussian intensity distribution (e.g., with a typical aspect ratio of 1:2 or 1:3), and tapered amplifiers may have an active region that is elongated in one direction, resulting in a strongly elliptical output beam. In some laser applications, there may be a need to change a beam aspect ratio (e.g., making an elliptical beam more circular or vice versa, or making a rectangular beam more square or vice versa). For example, a beam with an elliptical aspect ratio may be problematic when the beam is to be coupled into a single-mode fiber that has a circular mode field or a near-circular mode field (e.g., elliptical or astigmatic beams are generally coupled with reduced efficiency). Accordingly, in a laser application where a beam needs to have a certain aspect ratio (e.g., circular, elliptical, rectangular, square, or the like), anamorphic optics may be used to adjust a larger beam diameter to a dimension of a smaller beam diameter (or vice versa) to produce a rotationally symmetric beam, transform a circular beam into an elliptical beam, and/or enlarge one elliptical axis to produce a beam with a higher aspect ratio.

For example, as shown in FIG. 1, a laser beam aspect ratio may be adjusted using a cylindrical lens telescope 110 that includes one or more cylindrical lens pairs. For example, a cylindrical lens telescope 110 includes a negative cylinder lens followed by a positive cylinder lens to scale a shorter elliptical axis to a longer axis. To compensate for divergence induced in one direction, a distance between the cylindrical lenses may be adjusted. Due to the two-element design, a cylindrical lens telescope 110 can achieve high beam quality using simple plano-convex and plano-concave cylinder lenses. Lens curvatures and glasses may be selected such that the aberrations of both lenses cancel each other out, resulting in overall low aberration. Alternatively, another common technique to adjust a laser beam aspect ratio is to use an anamorphic prism pair 120. For example, FIG. 1 illustrates an example where three parallel rays of a beam pass through an anamorphic prism pair 120, where a distance between the rays changes, and the beam diameter in a direction of the plane likewise changes. For example, in FIG. 1, a top ray and a bottom ray are separated by a first distance, DIN, representing a beam diameter at an input of the anamorphic prism pair 120, and are separated by a second distance, DOUT, at an output of the anamorphic prism pair 120. In this way, the anamorphic prism pair 120 may expand a beam diameter in one axis when the input beam arrives at the anamorphic prism pair 120 in a first direction (e.g., from left-to-right in FIG. 1), or may shorten a beam diameter in one axis when the input beam arrives at the anamorphic prism pair 120 in an opposite direction (e.g., from right-to-left in FIG. 1).

However, approaches that use a cylindrical lens telescope 110 and/or an anamorphic prism pair 120 suffer from various practical drawbacks. For example, although cylindrical lenses used in a cylindrical lens telescope 110 can avoid a beam offset or deviation (e.g., a beam always stays centered), cylindrical lenses are very alignment-sensitive (e.g., the cylindrical axes need to be precisely aligned with one another), and do not enable an adjustable magnification (M). Furthermore, in some laser applications, providing a beam offset or deviation may be desirable. In addition, although an anamorphic prism pair 120 can provide robust, stable, and distortion-free adjustment to an asymmetric laser beam aspect ratio, an anamorphic prism pair 120 tends to offset the beam significantly (e.g., laterally displacing an optical axis), which is incompatible with out-of-plane asymmetry correction. Furthermore, although an anamorphic prism pair 120 can provide adjustable magnification, an anamorphic prism pair 120 tends to offset the beam awkwardly, and beam adjustment is difficult in practice and causes the beam offset to change as well (e.g., both prisms need to be rotated by different amounts). Other beam adjustment techniques also suffer from various drawbacks, such as a single prism causing severe beam deviation. Furthermore, typical single prisms, prism pairs, and/or cylindrical telescopes operate at fixed magnifications (e.g., about M=2 or M=3, in reverse, at about M=0.5 or M=0.33) and are therefore useful only in applications where a known, fixed, and/or possibly large magnification is required.

Accordingly, some implementations described herein relate to a single, unitary optical prism designed to easily and adjustably reshape a moderately elliptical beam (e.g., with an aspect ratio in a range between 0.70 and 1.30) into a more circular beam (e.g., with an aspect ratio close to 1.00), or vice versa. For example, in some implementations, the anamorphic prism described herein is designed to be centered at a neutral point (e.g., a magnification of 1.0), with an adjustable anamorphic (e.g., one-dimensional) magnification from 0.70 up to 1.3 or another suitable range over which an ellipticity of a high-power laser may vary in production. In some implementations, the adjustable magnification may be provided by rotating the anamorphic prism by an amount on the order of ±10 degrees. Furthermore, the anamorphic prism may be designed such that a direction in which the output beam points is largely insensitive to (e.g., independent from) the adjustment (e.g., rotating the prism to adjust the magnification does not significantly steer the beam). In some implementations, the anamorphic prism may be designed for a nominal deviation of zero degrees (straight-through), 90 degrees, or another suitable value as needed or as convenient in a particular application. In this way, the anamorphic prism described herein may provide an easily adjusted anamorphic magnification without significant beam steering and is well-suited for shaping beams where a variable and moderate magnification centered around a 1.0 magnification is needed, with either magnification or demagnification possible from that point with continuous adjustability.

As indicated above, FIG. 1 is provided as an example. Other examples may differ from what is described with regard to FIG. 1.

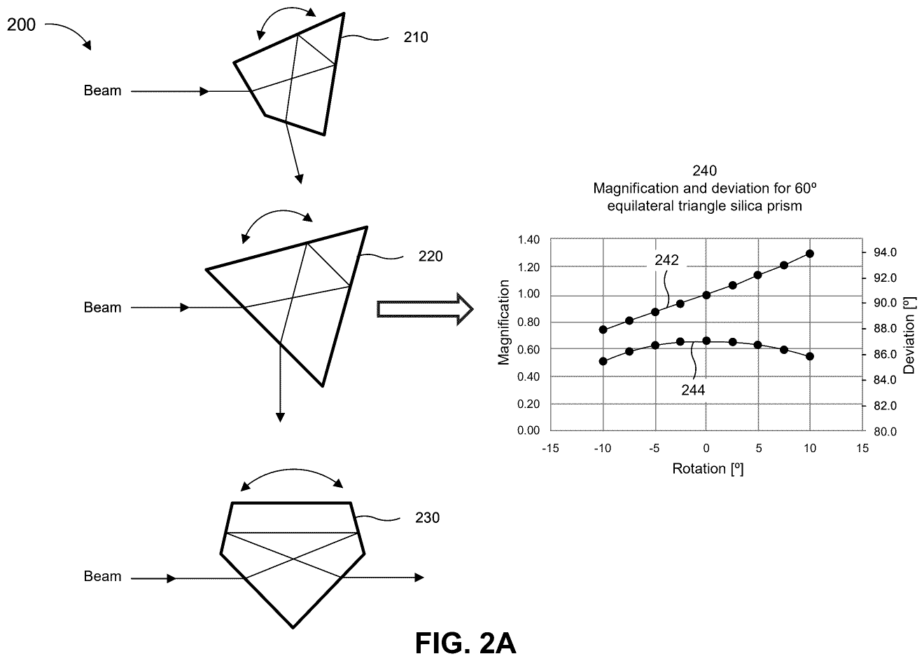

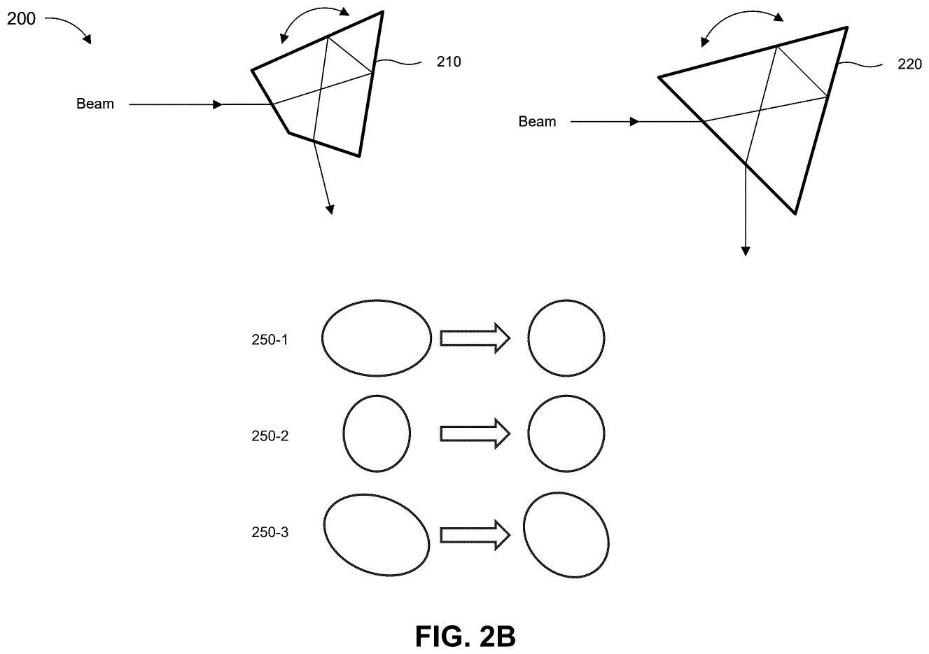

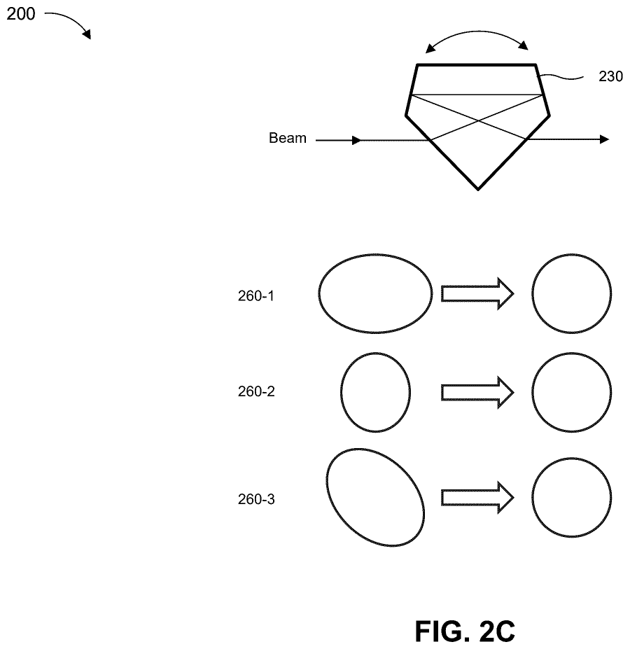

FIGS. 2A-2C are diagrams illustrating example implementations 200 of an adjustable anamorphic prism for tuning a beam aspect ratio. As described herein, a laser may generate a beam that is elliptical or non-circular for various possible reasons. In laser applications where an elliptical beam is to be reshaped to more closely approximate a circle, or there is otherwise a need to increase or decrease an ellipticity of the beam, the beam may be reshaped using an optical component or an optical system that has a different magnification (M) in a first axis as compared to a second axis that is perpendicular to the first axis. For example, after passing through the optical component or optical system, one axis of the beam is generally unchanged whereas the other axis is scaled by a factor of M, which may be greater than or less than 1 (e.g., the length of the scaled axis increases when M>1, or decreases when M<1).

In some implementations, as shown in FIG. 2A, an adjustable anamorphic prism may have a quadrilateral design 210 that provides a beam deviation at or near 90 degrees, a triangular design 220 that provides a beam deviation at or near 90 degrees, and/or a pentagonal design 230 that provides a beam deviation at or near 0 degrees, and/or another suitable design (e.g., a quadrilateral design that provides a beam deviation at or near 0 degrees). In some implementations, as described herein, the various designs 210-230 may share certain properties, including that a laser beam enters the anamorphic prism through an entrance face and exits the anamorphic prism through an exit face (e.g., where the entrance face and the exit face may be the same face, as in the triangular design 220, or different faces, as in the quadrilateral design 210 and/or the pentagonal design 230). In addition, in each design 210-230, the beam makes an even number of internal reflections (e.g., two internal reflections in example designs 210-230) off a set of internal faces inside the anamorphic prism, and the beam follows an crossing beam path or optical path from the entrance face to the exit face (e.g., the beam path forms a loop that crosses over itself). In some implementations, the entrance face and the exit face may have an anti-reflection (AR) coating, and internal reflection faces may have a high reflection (HR) coating. For example, in some implementations, the entrance face and the exit face may have an AR coating to suppress unwanted reflections at the entrance face and the exit face, and the internal reflection faces may have an HR coating to reflect the beam inside the anamorphic prism.

In some implementations, the various designs 210-230 for the adjustable anamorphic prism may allow an anamorphic magnification, M, to be tuned within 1.0±0.3 (e.g., in a range from 0.70 to 1.30) by tilting the prism from a neutral point by about ±10 degrees. In some implementations, the neutral point may correspond to a point at which an output aspect ratio equals an input aspect ratio. For example, in some implementations, a relatively higher angle of incidence (AOI) may provide a magnification scaling factor of M>1 to increase a beam radius in one axis (e.g., achieved by rotating the anamorphic prism from the neutral point in a counter-clockwise (CCW) direction), and a relatively lower AOI may provide a magnification scaling factor of M<1 to decrease the beam radius in one axis (e.g., achieved by rotating the anamorphic prism from the neutral point in a clockwise (CW) direction). Furthermore, tuning the anamorphic magnification by rotating the anamorphic prism relative to the neutral point causes less than a 1 millimeter (mm) offset to the beam axis, and a beam deviation of less than about 2 degrees (e.g., two internal reflections cause a propagation axis of the beam to deviate by respective amounts that cancel each other out). Furthermore, in some implementations, any offset and/or deviation to the beam propagation axis that occurs when the beam is output via the exit face of the anamorphic prism can be corrected using one or more subsequent fold mirrors or other suitable optical devices in an optical path located downstream from the exit face.

For example, FIG. 2A depicts a plot 240 showing how rotating an anamorphic prism fabricated from fused silica using the triangular design 220 (e.g., with three 60 degree angles) in a range from ±about 10 degrees allows a change in magnification from about 0.7× to 1.3×, and the beam deviation stays relatively constant near 90 degrees (e.g., in a range from about 85 to 87 degrees), which is a particularly useful value in rectilinear internal layouts that are often used in laser systems. For example, curve 242 depicts the magnification provided by the anamorphic prism in one axis as a function of the angle at which the anamorphic prism is rotated relative to the neutral point, where a rotation of 0 degrees provides M=1, a rotation in a first (e.g., positive or CCW) direction up to 10 degrees provides a magnification up to M=1.3, and a rotation in a second (e.g., negative or CW) direction up to −10 degrees provides a magnification down to M=0.7. Furthermore, curve 244 depicts the deviation of the beam as a function of the angle at which the anamorphic prism is rotated relative to the neutral point, which remains relatively stable (e.g., varies by less than about ±2 degrees) and is therefore substantially independent from the angle at which the anamorphic prism is rotated relative to the neutral point and/or any adjustment to the magnification provided by the anamorphic prism.

As shown in FIG. 2B, the quadrilateral design 210 and the triangular design 220 are example designs for the anamorphic prism that provide a 90 degree or near −90 degree beam deviation. In the triangular design 220, the same face is used for both the entrance face and the exit face, which proves a larger clear aperture than the quadrilateral design 210 for a given size of the anamorphic prism and a given length of the optical path within the anamorphic prism. In some cases, an anamorphic prism that provides a 90 degree or near −90 degree beam deviation can fully correct only a beam ellipticity that has axes parallel or perpendicular to a plane of the deviation provided by the anamorphic prism (e.g., a plane defined by the propagation axis before and after the deviation provided by the anamorphic prism). For example, in FIG. 2B, reference numbers 250-1 and 250-2 show beam ellipticity corrections in which the beam ellipticity has axes parallel or perpendicular to a plane of the 90 degree deviation provided by the anamorphic prism, which allows the beam ellipticity to be adjusted to achieve a circular aspect ratio. In contrast, reference number 250-3 shows a beam ellipticity that has an uncorrectable component rotated at 45 degrees with respect to the deviation provided by the anamorphic prism. In other words, the prism designs that provide 90 degree or near −90 degree beam deviation can correct asymmetry only along a horizontal (x) axis or a vertical (y) axis, defined relative to a plane of the deviation provided by the anamorphic prism, and cannot correct a 45 degree or other non-parallel/non-perpendicular asymmetry because the beam is intended to stay in a horizontal plane such that the magnification is horizontal.

In some implementations, exact designs of the anamorphic prisms that provide 90 degree or near −90 degree beam deviation may depend on a refractive index of a material used to make the anamorphic prism. For example, a fused silica equilateral triangular prism, as in the triangular design 220, is easily fabricated and provides about an 87 degree deviation with a refractive index of 1.45. Alternatively, an anamorphic prism with a triangular design could be designed to provide an exactly 90 degree deviation, but such as anamorphic prism would not be exactly equilateral and therefore potentially more difficult to fabricate. In some implementations, a design of the anamorphic prism providing a 90 degree or near −90 degree deviation can be used as a drop-in to a turning mirror mount (e.g., a mount for a turning mirror that reflects a beam at a 90 degree angle), and any remaining deviation or offset can be removed by adjusting a second turning mirror. Additionally, in an anamorphic prism that provides a 90 degree or near −90 degree beam deviation, a polarization of the beam may be aligned parallel or perpendicular to the plane of the beam deviation. Alternatively, in cases where an alignment of the polarization of the beam is neither parallel nor perpendicular to the plane of the 90 degree deviation, the anamorphic prism may have a special coating to maintain polarization.

As shown in FIG. 2C, the pentagonal design 230 may provide a zero or near-zero degree beam deviation, where the beam path is essentially unchanged after transiting the anamorphic prism. With the pentagonal design 230 or another suitable (e.g., quadrilateral) design that provides a zero or near-zero degree beam deviation, the anamorphic prism may be mounted with two degrees of rotational freedom, where the anamorphic prism may be rotated or tilted by a first angle in a pitch dimension to adjust the magnification, and rotated or tilted by a second angle in a roll dimension (e.g., around the beam axis, without deviating the beam). The rotation in the roll dimension allows the anamorphic prism to be oriented rotationally to correct any orientation of the beam ellipticity. For example, in some implementations, the anamorphic prism may be mounted in a holder with an axial rotatability (e.g., enabling adjustment in the roll dimension) and a prism tilt adjustability (e.g., a pitch and/or yaw adjustment) for a given magnification. In this way, as shown by reference numbers 260-1, 260-2, and 260-3, an anamorphic prism that provides a zero or near-zero degree deviation can perfectly correct asymmetry on any axis. In some implementations, in a design of the anamorphic prism that provides a zero or near-zero degree beam deviation, the anamorphic prism may have one or more coatings to maintain a polarization of the beam when the anamorphic prism is rotated. For example, AR coatings on the entrance and exit faces and HR coatings on the internal reflective faces may need a low polarization phase delay to avoid degrading beam polarization when the anamorphic prism is rotated. Accordingly, the AR and HR coatings may be selected to provide a near-zero phase delay relative to a polarization of the beam at each respective coating. Alternatively, the AR and HR coatings may each have non-negligible phase delays relative to the polarization of the beam that sum to a negligible (e.g., zero or near-zero) phase delay over the various faces.

As indicated above, FIGS. 2A-2C are provided as examples. Other examples may differ from what is described with regard to FIGS. 2A-2C.

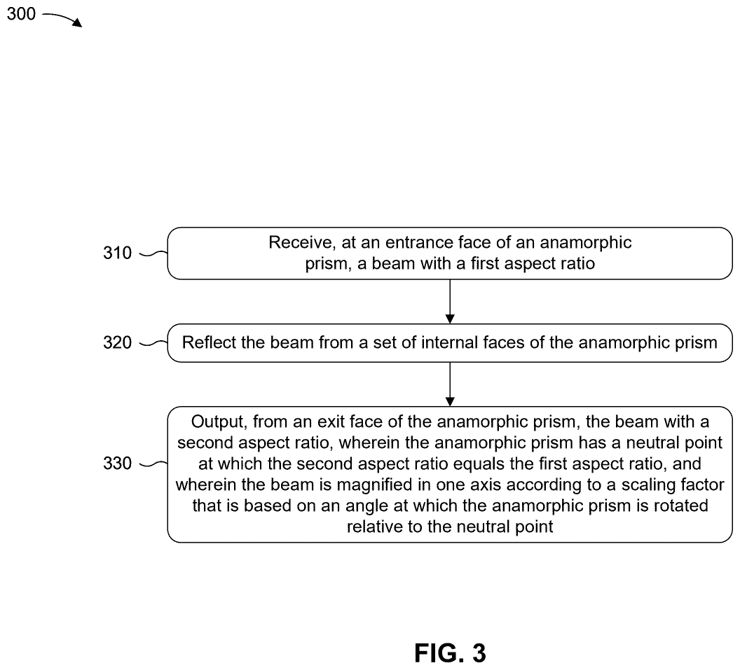

FIG. 3 is a flowchart of an example process 300 associated with tuning a beam aspect ratio using an adjustable anamorphic prism. In some implementations, one or more process blocks of FIG. 3 are performed by an anamorphic prism providing an adjustable magnification and a desired beam deviation (e.g., an anamorphic prism with a quadrilateral design 210 or triangular design 220 providing an adjustable magnification and a 90 degree or near −90 degree beam deviation, an anamorphic prism with a pentagonal design 230 providing an adjustable magnification and a 0 degree or near −0 degree beam deviation, or the like).

As shown in FIG. 3, process 300 may include receiving, at an entrance face of an anamorphic prism, a beam with a first aspect ratio (block 310). For example, the anamorphic prism may receive, at an entrance face, a beam with a first aspect ratio, as described above.

As further shown in FIG. 3, process 300 may include reflecting the beam from a set of internal faces of the anamorphic prism (block 320). For example, the anamorphic prism may include a set of internal faces that reflect the beam, as described above.

As further shown in FIG. 3, process 300 may include outputting, from an exit face of the anamorphic prism, the beam with a second aspect ratio, wherein the anamorphic prism has a neutral point at which the second aspect ratio equals the first aspect ratio, and the beam is magnified in one axis according to a scaling factor that is based on an angle at which the anamorphic prism is rotated relative to the neutral point (block 330). For example, the anamorphic prism may output, from an exit face, the beam with a second aspect ratio. In some implementations, the anamorphic prism has a neutral point at which the second aspect ratio equals the first aspect ratio. In some implementations, the beam is magnified in one axis according to a scaling factor that is based on an angle at which the anamorphic prism is rotated relative to the neutral point, as described above. In some implementations, the beam may be shaped, causing the aspect ratio to change, when the beam is refracted at the entrance face and the exit face. For example, a first refraction event may occur when the beam is received at the entrance face and/or after the beam is received at the entrance face and before the beam is reflected from the set of internal faces of the anamorphic prism. Furthermore, a second refraction event may occur when the beam is output at the exit face and/or after the beam is reflected from the set of internal faces and before the beam is output by the exit face of the anamorphic prism, where the first refraction event and the second refraction event cause the aspect ratio of the beam to change from the first aspect ratio to the second aspect ratio.

Process 300 may include additional implementations, such as any single implementation or any combination of implementations described below and/or in connection with one or more other processes described elsewhere herein.

In a first implementation, the scaling factor is in a range from 0.70 to 1.30 based on the anamorphic prism being rotated relative to the neutral point by ±10 degrees.

In a second implementation, alone or in combination with the first implementation, a value of the scaling factor is greater than 1 based on the angle at which the anamorphic prism is rotated relative to the neutral point increasing an angle of incidence of the beam relative to the neutral point, or less than 1 based on the angle at which the anamorphic prism is rotated relative to the neutral point decreasing the angle of incidence of the beam relative to the neutral point.

In a third implementation, alone or in combination with one or more of the first and second implementations, the anamorphic prism has a shape that causes a propagation axis of the beam to deviate according to an angle that is substantially independent from the angle at which the anamorphic prism is rotated relative to the neutral point.

In a fourth implementation, alone or in combination with one or more of the first through third implementations, the anamorphic prism has a shape that causes a propagation axis of the beam to deviate by approximately 90 degrees.

In a fifth implementation, alone or in combination with one or more of the first through fourth implementations, an angle at which the propagation axis of the beam deviates is based on a refractive index of a material of the anamorphic prism.

In a sixth implementation, alone or in combination with one or more of the first through fifth implementations, the shape of the anamorphic prism is a quadrilateral such that the entrance face is different from the exit face.

In a seventh implementation, alone or in combination with one or more of the first through sixth implementations, the shape of the anamorphic prism is a triangle such that the entrance face is the exit face.

In an eighth implementation, alone or in combination with one or more of the first through seventh implementations, the one axis in which the beam is magnified is parallel or perpendicular to a plane defined by the propagation axis before and after the deviation by approximately 90 degrees.

In a ninth implementation, alone or in combination with one or more of the first through eighth implementations, a polarization of the beam is parallel or perpendicular to a plane defined by the propagation axis before and after the deviation by approximately 90 degrees.

In a tenth implementation, alone or in combination with one or more of the first through ninth implementations, the entrance face, the exit face, and the set of internal faces have respective coatings to maintain a polarization of the beam based on the polarization of the beam not being parallel or perpendicular to a plane defined by the propagation axis before and after the deviation by approximately 90 degrees.

In an eleventh implementation, alone or in combination with one or more of the first through tenth implementations, the anamorphic prism has a shape that causes a propagation axis of the beam to deviate by approximately zero degrees.

In a twelfth implementation, alone or in combination with one or more of the first through eleventh implementations, the scaling factor is based on a first angle at which the anamorphic prism is rotated relative to the neutral point in a pitch dimension, and the one axis in which the beam is magnified is based on a second angle at which the anamorphic prism is rotated in a roll dimension.

In a thirteenth implementation, alone or in combination with one or more of the first through twelfth implementations, the entrance face, the exit face, and the set of internal faces have respective coatings to maintain a polarization of the beam.

In a fourteenth implementation, alone or in combination with one or more of the first through thirteenth implementations, the respective coatings each provide a near-zero phase delay relative to the polarization of the beam.

In a fifteenth implementation, alone or in combination with one or more of the first through fourteenth implementations, the respective coatings have non-negligible phase delays relative to the polarization of the beam that sum to a negligible phase delay near-zero over the entrance face, the exit face, and the set of internal faces.

In a sixteenth implementation, alone or in combination with one or more of the first through fifteenth implementations, the entrance face and the exit face have an anti-reflection coating, and the set of internal faces have a high reflection coating.

In a seventeenth implementation, alone or in combination with one or more of the first through sixteenth implementations, the beam makes an even number of internal reflections and follows a crossing beam path inside the anamorphic prism.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An anamorphic prism, comprising:
an entrance face arranged to receive a beam with a first aspect ratio;
a set of internal faces arranged to reflect the beam; and
an exit face arranged to output the beam with a second aspect ratio, wherein:
the anamorphic prism has a neutral point at which the second aspect ratio equals the first aspect ratio, and
the beam is magnified in one axis according to a scaling factor that is based on an angle at which the anamorphic prism is rotated relative to the neutral point.

2. The anamorphic prism of claim 1, wherein the scaling factor is in a range from 0.70 to 1.30 based on the anamorphic prism being rotated relative to the neutral point by ±10 degrees.

3. The anamorphic prism of claim 1, wherein a value of the scaling factor is:
greater than 1 based on the angle at which the anamorphic prism is rotated relative to the neutral point increasing an angle of incidence of the beam relative to the neutral point, or
less than 1 based on the angle at which the anamorphic prism is rotated relative to the neutral point decreasing the angle of incidence of the beam relative to the neutral point.

4. The anamorphic prism of claim 1, wherein the anamorphic prism has a shape that causes a propagation axis of the beam to deviate according to an angle that is substantially independent from the angle at which the anamorphic prism is rotated relative to the neutral point.

5. The anamorphic prism of claim 1, wherein the anamorphic prism has a shape that causes a propagation axis of the beam to deviate by approximately 90 degrees.

6. The anamorphic prism of claim 5, wherein an angle at which the propagation axis of the beam deviates is based on a refractive index of a material of the anamorphic prism.

7. The anamorphic prism of claim 5, wherein the shape of the anamorphic prism is a quadrilateral such that the entrance face is different from the exit face.

8. The anamorphic prism of claim 5, wherein the shape of the anamorphic prism is a triangle such that the entrance face is the exit face.

9. The anamorphic prism of claim 5, wherein the one axis in which the beam is magnified is parallel or perpendicular to a plane defined by the propagation axis before and after the deviation by approximately 90 degrees.

10. The anamorphic prism of claim 5, wherein a polarization of the beam is parallel or perpendicular to a plane defined by the propagation axis before and after the deviation by approximately 90 degrees.

11. The anamorphic prism of claim 5, wherein the entrance face, the exit face, and the set of internal faces have respective coatings to maintain a polarization of the beam based on the polarization of the beam not being parallel or perpendicular to a plane defined by the propagation axis before and after the deviation by approximately 90 degrees.

12. The anamorphic prism of claim 1, wherein the anamorphic prism has a shape that causes a propagation axis of the beam to deviate by approximately zero degrees.

13. The anamorphic prism of claim 12, wherein:
the scaling factor is based on a first angle at which the anamorphic prism is rotated relative to the neutral point in a pitch dimension, and
the one axis in which the beam is magnified is based on a second angle at which the anamorphic prism is rotated in a roll dimension.

14. The anamorphic prism of claim 12, wherein the entrance face, the exit face, and the set of internal faces have respective coatings to maintain a polarization of the beam.

15. The anamorphic prism of claim 14, wherein the respective coatings each provide a near-zero phase delay relative to the polarization of the beam.

16. The anamorphic prism of claim 14, wherein the respective coatings have non-negligible phase delays relative to the polarization of the beam that sum to a negligible phase delay near-zero over the entrance face, the exit face, and the set of internal faces.

17. The anamorphic prism of claim 1, wherein:
the entrance face and the exit face have an anti-reflection coating, and
the set of internal faces have a high reflection coating.

18. The anamorphic prism of claim 1, wherein the beam makes an even number of internal reflections and follows a crossing beam path inside the anamorphic prism.

19. An anamorphic prism, comprising:
an entrance face;
an exit face; and
a set of internal faces, wherein the entrance face, the exit face, and the set of internal faces are arranged to:
provide a crossing optical path having an even number of internal reflections from the set of internal faces; and
variably magnify a beam transmitted on the crossing optical path from the entrance face to the exit face based on an angle at which the anamorphic prism is rotated.

20. A method for tuning a beam aspect ratio, comprising:
receiving, at an entrance face of an anamorphic prism, a beam with a first aspect ratio;
reflecting the beam from a set of internal faces of the anamorphic prism; and
outputting, from an exit face of the anamorphic prism, the beam with a second aspect ratio, wherein:
the anamorphic prism has a neutral point at which the second aspect ratio equals the first aspect ratio, and
the beam is magnified in one axis according to a scaling factor that is based on an angle at which the anamorphic prism is rotated relative to the neutral point.
